(19) United States
(12) Patent Application Publication
(10) Pub. No.: US 2021/0376420 A1
(43) Pub. Date: Dec. 2, 2021

(54) BATTERY HOUSING OF A TRACTION BATTERY DEVICE FOR A MOTOR VEHICLE AND METHOD FOR FILLING UP AN INTERMEDIATE GAP

(71) Applicant: Mahle International GmbH, Stuttgart (DE)

(72) Inventor: Bernhard Klotz, Winnenden (GB)

(21) Appl. No.: 17/331,627

(22) Filed: May 26, 2021

(30) Foreign Application Priority Data
May 27, 2020 (DE) 102020206607.8

(51) Int. Cl. H01M 50/249; B60L 50/64; H01M 50/204; H01M 50/627

(52) U.S. Cl. CPC H01M 50/249; B60L 50/64; H01M 2220/20; H01M 50/627; H01M 50/204

(57) ABSTRACT

A battery hosing of a traction battery device for a motor vehicle may include a traction battery and at least one housing outer wall. The traction battery may include at least one electric cell unit inserted in the battery housing. The at least one housing outer wall may form the battery housing and may including a backflow preventer.

### CROSS-REFERENCE TO RELATED APPLICATION

This application claims priority to German Application No. DE 10 2020 206 607.8 filed on May 27, 2020, the contents of which are hereby incorporated by reference in its entirety.

### TECHNICAL FIELD

The invention relates to a battery housing of a traction battery device for a motor vehicle according to the preamble of claim 1. The invention, furthermore, relates to a method for filling up an intermediate gap.

### BACKGROUND

In DE 10 2007 049 367 A1 a dosing device is described, which comprises a fluid reservoir and a fluid pump, wherein the fluid pump fluidically communicates with the fluid reservoir by way of an adapter fixed to the reservoir in order to convey fluid out of the fluid reservoir. The said adapter comprises a backflow preventer, which shuts off a backflow of fluid out of the adapter into the fluid reservoir. During the manufacture of a battery housing mentioned at the outset a said dosing device can be employed if required in order to fill up with a filling fluid intermediate gaps brought about by the design. In practice it has been shown however that filling fluid flowed into the battery housing can, after the completion of the actual dosing operation, partly flow back and drip off the battery housing in an uncontrolled manner. This results in particular in dirtying the manufacturing tools, which is undesirable in the process for technical and economic reasons.

### SUMMARY

The object of the invention therefore lies in providing an improved or at least another embodiment of a battery housing. In particular, the invention has set itself the task of stating a method of filling up an intermediate gap in such a battery housing.

With the present invention, this object is solved through the subjects of the independent claims. Advantageous embodiments are subject of the dependent claims and the description.

The basic idea of the invention lies in equipping a said battery housing of a traction battery device with a backflow preventer. According to the invention, it is initially provided for this purpose that a traction battery, in particular a traction battery for a motor vehicle, is completely inserted into a battery housing. Here, the battery housing can be embodied closed all around so that it completely chambers the inserted traction battery. The traction battery itself can comprise at least one or multiple electric cell units, for example rechargeable cell units. It is substantial for the invention that at least one housing outer wall forming the battery housing comprises a backflow preventer. Here it is practically known to the person skilled in the art that a housing outer wall of a corresponding battery housing can be that housing wall which is freely accessible from the outside, in particular without disassembly of the battery housing, for example for manufacturing tools or the like. A backflow preventer according to the invention has the flow-optimising effect of unblocking a fluid flow of filling fluid through the respective housing outer wall in the one direction and shutting the same off in the opposite direction.

In particular, the backflow preventer can unblock a filling flow of filling fluid flowing into the battery housing and shut off a backflow of the filling fluid out of the battery housing. Because of this, the grouting or filling up of air-filled or gas-filled or completely evacuated intermediate spaces or air-filled or gas-filled or completely evacuated intermediate gaps present in the battery housing can be controlled within the scope of the manufacture of a battery housing so that the flowed-in filling fluid utilised for the grouting can flow into the battery housing where it can flow into the respective intermediate spaces or intermediate gaps. However, a backflow of the filling fluid is shut off, i.e. blocked. Thus, the flowed-in filling fluid during the grouting of intermediate spaces etc. cannot flow back out again. Because of this, no leakages in particular occur any longer during the manufacture of a corresponding battery housing so that in particular dirtying of the manufacturing tools is prevented. The employed filling fluid can preferably be realised through a filling liquid or a filling paste.

In order to provide the flow-optimising effect, it is practical, furthermore, that the backflow preventer comprises at least one injector passage for conducting filling fluid and at least one non-return valve for unblocking the filling flow and shutting-off the backflow.

Here, a respective non-return valve is assigned to a respective injector passage, for example touchingly attached to the same. Practically, the non-return valve allows unblocking the filling flow through the injector passage and shut off the backflow. Further practically, the respective injector passage tunnels through a respective housing outer wall completely in order to ensure altogether that filling fluid can flow into the battery housing from outside the batter housing.

In particular, the respective non-return valve can be configured so that in at least an open position it unblocks a filling flow of filling fluid flowing into the battery housing in a passage direction of the respective non-return valve through the respective injector passage. Furthermore it is configured so that in a shut-off position it shuts off a return flow of the same filling fluid flowing back out of the battery housing through the respective injector passage in a counter-passage direction that is opposite to the passage direction. Consequently, the non-return valve can have exactly one shut-off position and multiple open positions. In the shut-off position, the respective non-return valve can quasi seal the respective injector passage and prevent filling fluid from escaping.

It is practical, furthermore, when at least one respective injector passage completely tunnels through a respective housing outer wall of the battery housing, at one end leading into the battery housing forming an inner mouth opening and on the other end, forming a runner mouth opening facing away from the inner mouth opening, leads out in particular towards the atmosphere surrounding the battery housing. Practically, a respective injector passage can be formed through a clearance in the battery housing or in the housing outer wall. This clearance can be realised for example by a drilled hole or punched hole. This has the effect that fluid, in particular the filling fluid, can flow through a housing outer wall. The clearance, the punched hole or the drilled hole can be practically completely rimmed all around by a component that is relatively soft compared with the respective housing outer wall, for example a sealant having elastic properties, in order to simplify a sealing between on the one hand a dosing head (injector tip) of a feeding device and the respective clearance, punched hole or drilled hole and to avoid wear on the dosing head (injector tip).

It is practical, furthermore, when between the traction battery and the respective housing outer wall at least one intermediate gap filled by air or gas or completely evacuated is defined, wherein the said inner mouth opening leads into a respective intermediate gap at least in sections. This has the effect that filling fluid can flow into this respective intermediate gap from the outside in order to fill up this intermediate gap. During the grouting, filling up, the air or gas present in the respective intermediate gap can initially escape, in particular through the respective injector passage, provided the intermediate gap is not completely evacuated. The result is that by means of an intermediate gap grouted, i.e. filled up with filling fluid, the heat conductivity for example between the traction battery and the battery housing, in particular of the respective housing outer wall can be optimised. In practice, the respective intermediate gap can be practically completely or completely filled up with filling fluid.

Practically, the said runner mouth opening can be arranged on a respective non-return valve. Practically, the corresponding non-return valve touchingly supports itself on the respective housing outer wall and covers the runner mouth opening completely. The non-return valve can form a fluid inlet for filling fluid that is accessible from the outside, docking onto which is possible with an opener, in particular a dosing head of a feeding device for filling fluid to flow in.

Furthermore, the said backflow preventer can comprise at least one delay chamber or form the same.

In particular, the respective injector passage can form the delay chamber. Alternatively, the said runner mouth opening of the respective injector passage can also lead into a respective delay chamber. Practically, this delay chamber can quasi completely chamber and cover the runner mouth opening of the respective injector passage all around, as a result of which the delay chamber can in particular collect or receive in particular the backflow of filling fluid. Furthermore, in particular the delay chamber can define a chamber volume that is adapted or adaptable to the backflow initially filled by air. The result is that the delay chamber can provide a pressure-reducing and flow speed-retarding effect on the filling fluid of the backflow, since the backflow of filling fluid initially displaces the air out of the delay chamber and gradually fills up the same. Combined, this can have the effect that the back-flowing filling fluid reaches a filling passage formed by the delay chamber with a delay. The said filling passage can practically lead out towards the atmosphere surrounding the battery housing, so that it is accessible from the outside. Practically, a respective non-return valve is arranged on this filling passage, wherein the said non-return valve can form a fluid inlet for filling fluid that is accessible from the outside, docking onto which is possible for example with a dosing head for the inflow of filling fluid of a feeding device.

Further practically, the respective delay chamber can be formed by a main body having a clearance that is open on one side, and the respective housing outer wall, wherein this main body, with its open clearance upfront, is touchingly placed onto the respective housing outer wall. Because of this, the main body that is open on one side is arranged with its open clearance quasi over the injection passage so that back-flowing filling fluid can flow into the open clearance or the delay chamber. Practically, the said filling passage of the delay chamber is also formed by the main body. Practically, the respective non-return valve touchingly supports itself on the main body and covers the filling passage completely.

Practically, a respective non-return valve can form a diaphragm non-return valve. The diaphragm non-return valve can comprise a slit or punched valve diaphragm. By way of this, the respective non-return valve can be cost-effectively realised.

Further practically, the respective valve diaphragm can be configured pot-shaped and comprise a valve bottom that is framed by a completely circumferential, integrally arranged valve wall, wherein the valve bottom, in a central region spaced apart from the valve wall, is slit or punched one time or multiple times linearly, cruciformly or radially forming at least one moveable valve flap. By way of this, an advantageous design configuration is stated.

Practically, the respective valve flaps can each have a contact surface, wherein these contact surfaces in each open position of the respective non-return valve frame a valve opening, through which the filling flow of filling liquid extends in each case. In the shut-off position of the respective non-return valve, the contact surfaces touchingly lie against one another in a sealed manner, so that the backflow of the same filling fluid is shut off

Further practically, the valve diaphragm can be produced from a silicone material, a rubber or a thermoplastic elastomer (TPE). Alternatively or additionally it can be provided, furthermore, that the respective valve flaps are automatically elastically preloaded into the shut-off position, and/or that the respective valve flaps are moved or can be moved by means of the filling fluid or by means of an opener into the at least one open position. An opener can be formed by a dosing head of a feeding device.

Practically, the filling fluid can be formed by a volume filling material, in particular a gap filler material or a heat-conductive paste. Following the inflow into the battery housing, the filling fluid can harden, practically in a volume-expanding manner, in particular in a respective intermediate gap.

Further practically, the non-return valve can be clamped tightly against the housing outer wall tunnelled through by the respective injector passage or the main body by means of a holding plate of a plastic material, in particular of a thermoplastic such as polyamide. Here, the holding plate is latched in or pressed in on the housing outer wall or the main body. However it is possible, furthermore, that the non-return valve or the valve diaphragm of the same is directly moulded integrally into the housing outer wall or the main body.

Another basic idea of the invention, which can be realised additionally or alternatively to the basic idea mentioned further up, can lie in providing a method for filling up an intermediate gap that has been filled with air or gas or evacuated. To this end, the method according to the invention comprises a battery housing, in particular according to the preceding description, wherein between the traction battery of the battery housing and at least a housing outer wall forming the battery housing, a corresponding intermediate gap is formed. This housing outer wall is assigned a backflow preventer, in particular according to the preceding description. The method is characterised by the following steps:
1) Loading the valve flaps of a non-return valve of the backflow preventer by means of an opener, in particular a dosing head of a feeding device, so that these valve flaps are moved into an open position of the non-return valve;
2) Inflowing of filling fluid into the intermediate gap of the battery housing until the same is completely filled up or substantially or substantially completely filled up;
3) On loading the valve flaps, in particular retracting the opener so that the valve flaps automatically tension themselves elastically into the shut-off position of the non-return valve, wherein a backflow of the filling fluid flowing out of the intermediate gap of the battery housing is shut off through the valve flaps standing in the shut-off position.

In summary it should be noted: The present invention preferentially relates to a battery housing of a traction battery device for a motor vehicle, having a traction battery that is completely introduced into the battery housing that is closed all around comprising one or multiple electric cell units. It is substantial for the invention that at least one housing outer wall forming the battery housing comprises a backflow preventer.

Further important features and advantages of the invention are obtained from the sub Claims, from the drawing, and from the associated figure description by way of the drawings.

It is to be understood that the features mentioned above and still to be explained in the following cannot only be used in the respective combinations stated but also in other combinations or by themselves without leaving the scope of the present invention.

Preferred exemplary embodiments of the invention are shown in the drawing and are explained in more detail in the following description, wherein same reference numbers relate to same or similar or functionally same components.

### BRIEF DESCRIPTION OF THE DRAWINGS

It shows, in each case schematically

FIG. 1 in a sectional view a preferred exemplary embodiment of a battery housing according to the invention, wherein a non-return valve of a backflow preventer of the battery housing assumes an open position,

FIG. 2 in a sectional view the battery housing from FIG. 1, wherein the non-return valve assumes a shut-off position and

FIG. 3 a perspective view of the valve diaphragm of the none-return valve from FIGS. 1 and 2 and finally

FIG. 4 in a perspective view a further exemplary embodiment of a valve diaphragm for a non-return valve of a backflow preventer according to FIGS. 1 and 2.

### DETAILED DESCRIPTION

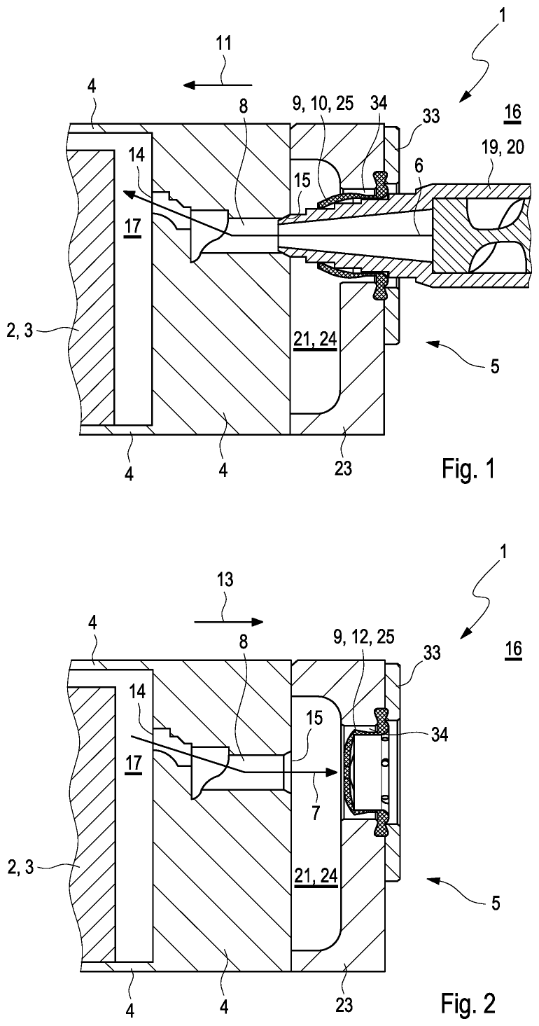

FIGS. 1 and 2 each show a battery housing 1 for a traction battery device for a motor vehicle, wherein the traction battery 2 which here is indicated only in a simplified manner and in sections is exemplarily inserted completely in the battery housing 1 and enclosed by the same all around. The traction battery 2 according to FIGS. 1 and 2 comprises multiple electric, in particular rechargeable cell units 3, wherein in FIGS. 1 and 2 for the sake of clarity, merely a single cell unit 3 each has been marked. Here, the battery housing 1 has multiple housing outer walls 4 which are each freely accessible from the outside and each shown sectioned, which form the battery housing 1. On one of these housing outer walls 4 a backflow preventer 5 is arranged or formed. The backflow preventer 5 is provided for the purpose of unblocking a filling flow 6, see FIG. 1, of filling fluid flowing into the battery housing 1 and shutting-off a backflow 7, see FIG. 2, of the same filling fluid out of the battery housing 1.

In the present exemplary embodiment, the backflow preventer 5 exemplarily shows an injector passage 8, which serves for conducing filling fluid through the housing outer wall 4, a non-return valve 9, which serves for unblocking the filling flow 6 through the injector passage 8 and for shutting-off the backflow 7, and a delay chamber 21.

The non-return valve 9 shown in FIGS. 1 to 3, is realised by a diaphragm non-return valve 25 which, by means of an opener 19 indicated in FIG. 1, exemplarily a dosing head 20, can be switched to and fro between multiple open positions 10 and a shut-off position 12, wherein in at least one of these open positions 10 it unblocks a filling flow 6 of filling fluid, flowing in a passage direction 11 through the injector passage 8 into the battery housing 1, see FIG. 1. In this case, the non-return valve 9 can form a fluid inlet. According to FIG. 2, the diaphragm non-return valve 25 assumes the shut-off position 12, wherein in a counter passage direction 13 opposite to the passage direction 11 it shuts off a backflow 7 flowing back out of the battery housing 1 through the injector passage 8 and the delay chamber 21.

The said injector passage 8 tunnels through, i.e. penetrates, the housing outer wall 4 completely and on the one end leads into an intermediate gap 17 of the battery housing 1 forming an inner mouth opening 14. The injector passage 8 and the intermediate gap 17 are fluidically connected to one another. Practically, the intermediate gap 17 is arranged or formed between the traction battery 2 and at least one housing outer wall 4 and prior to the grouting, i.e. filling up, with filling fluid completely filled with air or gas or completely evacuated. On the other end, the injector passage 8, forming a runner mouth opening 15, oriented with respect to the inner mouth opening 14 in the opposite direction preferably leads into the mentioned delay chamber 21. However it would basically be also possible to omit the delay chamber 21 so that the runner mouth opening 15 in this case would lead out towards the atmosphere 16 surrounding the battery housing 1.

The delay chamber 21 defines a chamber volume adapted or adaptable to the backflow 7 initially filled by air, which is filled up by back-flowing filling fluid. The filling up of the chamber volume or the delay chamber 21 has a pressure-reducing and flow speed-retarding effect on the back-flowing filling fluid. The delay chamber 21 is exemplarily formed by a main body 23 comprising a clearance 24 that is open on one side and the housing outer wall 4, namely in that the main body 23 is touchingly supported on the housing wall 4 so that the housing wall 4 seals the clearance 24 of the main body 23 all around. The delay chamber 21 practically comprises or forms a filling passage 34 that is accessible from the outside, onto which the opener 19 can be docked. Practically, the filling passage 34 forms a fluid inlet for filling fluid. The non-return valve 9 can be clamped tight by means of a holding plate 33 of a plastic material, in particular a thermoplastic such as polyamide, on the housing wall 4 tunnelled through by the injector passage 8 or the main body 21.

FIG. 3 shows in a perspective and slightly enlarged view, a valve diaphragm 26 of the non-return valve 9 from FIGS. 1 and 2 realised as diaphragm non-return valve 25. The valve diaphragm 26 as is also obvious from FIGS. 1 and 2, altogether has a pot shape. It has a valve bottom 27, which is integrally connected to a surrounding valve wall 28 on the rim side. The valve bottom 27 has a central region 29 that is arranged radially spaced apart from the valve wall 28, which is indicated by a dashed circle here. The central region 29 is exemplarily radially slit open by three slits that are angularly offset relative to one another. By way of the slits, multiple moveable valve flaps 30 are formed. The respective valve flaps 30 have circumferential contact surfaces 31 in sections formed along the slits. In the shut-off position 12 of the non-return valve 9 shown in FIG. 3, the contact surfaces 31 lie touchingly against one another so that the backflow 7 of filling fluid is shut off, see in particular FIG. 2. The contact surfaces 31 frame or delimit in each of the mentioned open positions 10 a valve opening 32, through which the filling flow 6 of filling fluid extends in each case, see in particular FIG. 1. Since the non-return valve 9 according to FIG. 3 the shut-off position 12, a corresponding valve opening 32 is indicated by a circle in a simplified manner.

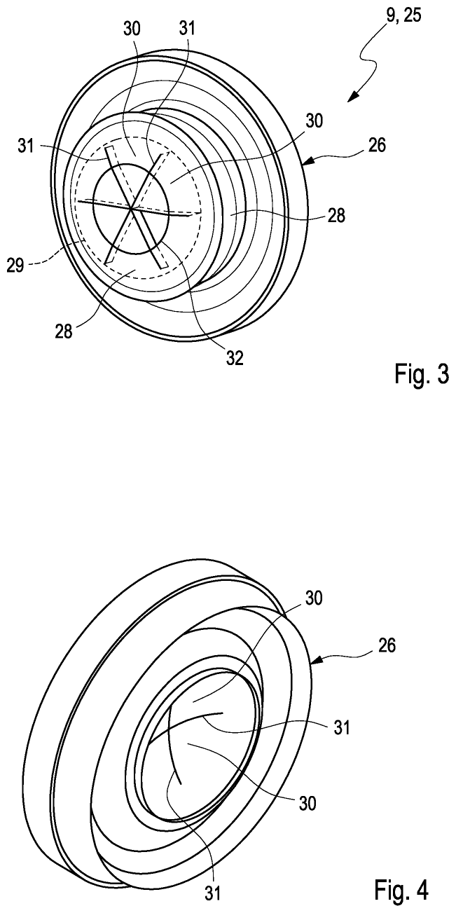

Finally, FIG. 4 shows a further diaphragm 26 which, deviating from the preceding valve diaphragm 26, has two slits and four valve flaps 30. This valve diaphragm 26 can be used alternatively to the preceding valve diaphragm 26. The valve diaphragm 26 according to FIG. 4 thus shows a design configuration deviating from the valve diaphragm 26 according to FIG. 3, but these are functionally identical.

1. A battery housing of a traction battery device for a motor vehicle, comprising:
a traction battery including at least one electric cell unit inserted into the battery housing; and
at least one housing outer wall forming the battery housing and including a backflow preventer.

2. The battery housing according to claim 1, wherein
the backflow preventer is configured to (i) unblock a filling flow of a filling fluid flowing into the battery housing and (ii) shut off a backflow of the filling fluid flowing out of the battery housing.

3. The battery housing according to claim 1, wherein
the backflow preventer includes (i) at least one injector passage for conducting a filling fluid and iii) at least one non-return valve for opening a filling flow of the filling fluid and shutting-off a backflow of filling fluid, and wherein a respective non-return valve is assigned to a respective injector passage.

4. The battery housing according to claim 3, wherein
the respective non-return valve when (i) an at least one open position, unblocks a filling flow of the filling fluid flowing in a passage direction of the respective non-return valve, through the respective injector passage and into the battery housing, and (ii) in a shut-off position, shuts off a backflow of the same filling fluid flowing back in a counter-passage direction that is opposite to the passage direction of the respective non-return valve, through the respective injector passage and out of the battery housing.

5. The battery housing according to claim 3, wherein
at least one respective injector passage completely tunnels through a respective housing outer wall of the battery housing, on one end forming an inner mouth opening that leads into the battery housing, and on the other end, forming a runner mouth opening that leads out and faces away from the inner mouth opening.

6. The battery housing according to claim 5, wherein
between the traction battery and the respective housing outer wall at least one intermediate gap is defined, and wherein the inner mouth opening leads into a respective intermediate gap at least in sections.

7. The battery housing according to claim 5, wherein
the respective non-return valve is arranged on the runner mouth opening.

8. The battery housing according to claim 5, wherein
the backflow preventer includes at least one delay chamber, and wherein the runner mouth opening of the respective injector passage leads into a respective delay chamber.

9. The battery housing according to claim 8, wherein
the respective delay chamber is formed by a main body having a clearance that is open on one side and by the respective housing outer wall, and wherein the main body with its open clearance upfront is placed onto the respective housing outer wall.

10. The battery housing according to claim 3, wherein
the backflow preventer forms a diaphragm non-return valve whose valve diaphragm is slit or punched.

11. The battery housing according to claim 10, wherein
the respective valve diaphragm is pot-shaped and has a valve bottom, onto which a completely surrounding valve wall is integrally moulded, and wherein the valve bottom, in a central region spaced apart from the valve wall, is slit or punched once or multiple times, linearly, cruciformly or radially forming at least one moveable valve flap.

12. The battery housing according to claim 11, wherein
the respective valve flaps each have contact surfaces.

13. The battery housing according to claim 10, wherein
the valve diaphragm is produced from a silicon material, a rubber or a thermoplastic elastomer.

14. The battery housing according to claim 2, wherein
the filling fluid is formed of a volume filling material, a gap filler material, or a heat-conductive paste, the filling fluid hardens after it has flowed into the battery housing.

15. A method for filling up an intermediate gap, comprising a battery housing formed from at least one housing outer wall, wherein between a traction battery completely inserted in the battery housing and the at least one housing outer wall at least one intermediate gap is formed, and wherein at least one of the respective housing outer walls is assigned a backflow preventer the method comprising the following steps:
loading valve flaps of a non-return valve of the backflow preventer by means of via an opener, in particular of a dosing head of a feeding device, so that the valve flaps are moved into an open position of the non-return valve;
inflowing of a filling fluid into the intermediate gap of the battery housing until the same is completely filled or substantially completely filled up; and
unloading the valve flaps, in particular retracting the opener, so that the respective valve flaps automatically tension themselves elastically into a shut-off position of the non-return valve, wherein a backflow of the filling fluid flowing out of the intermediate gap of the battery housing is shut off through the valve flaps standing in the shut-off position.

16. The battery housing according to claim 3, wherein a respective non-return valve forms a diaphragm non-return valve whose valve diaphragm is slit or punched.

17. The battery housing according to claim 16, wherein the respective valve diaphragm is pot-shaped and has a valve bottom onto which a completely surrounding valve wall is integrally moulded, and wherein the valve bottom, in a central region spaced apart from the valve wall, is slit or punched once or multiple times, linearly, cruciformly or radially forming at least one moveable valve flap.

18. The battery housing according to claim 17, wherein the respective valve flaps each have contact surfaces, wherein each of the contact surfaces in (i) an open position of the respective non-return valve frame a valve opening through which the filling flow of the filling fluid extends and (ii) in a shut-off position of the respective non-return valve contact one another in a sealed manner, so that the backflow of filling fluid is shut off

19. The battery housing according to claim 18, wherein the respective valve flaps are automatically preloaded elastically into the shut-off position.

20. The battery housing according to claim 18, wherein the respective valve flaps are moved or can be moved into at least one open position by the filling fluid or by an opener.
